(19) United States
(12) Patent Application Publication
(10) Pub. No.: US 2015/0171663 A1
(43) Pub. Date: Jun. 18, 2015

(54) UNINTERRUPTIBLE POWER SYSTEMS USING CURRENT SOURCE RECTIFIERS AND METHODS OF OPERATING THE SAME

(71) Applicant: Eaton Corporation, Cleveland, OH (US)

(72) Inventors: Slobodan Krstic, Brookfield, WI (US); Yu Liu, Katy, TX (US)

(73) Assignee: Eaton Corporation, Cleveland, OH (US)

(21) Appl. No.: 14/132,652

(22) Filed: Dec. 18, 2013

(51) Int. Cl. H02J 9/06; H02J 7/02; H02M 1/096; H02M 7/23; H02M 3/158

(52) U.S. Cl. CPC H02J 9/061; H02M 7/23; H02M 3/158; H02M 1/096; H02J 7/02

(57) ABSTRACT

An apparatus includes a current source rectifier circuit having an input configured to be coupled to an AC power source and an output configured to be coupled to a load, a coupling circuit configured to couple a DC power source to the current source rectifier, and a control circuit configured to selectively operate the current source rectifier circuit and the coupling circuit to generate a DC output from the AC power source and the DC power source. In some embodiments, the control circuit may be configured to operate the coupling circuit to provide a DC/DC converter circuit that uses an energy storage inductor of the current source rectifier circuit. The apparatus may further include a freewheeling diode shared by the current source rectifier circuit and the DC/DC converter circuit. Such apparatus may be used, for example, in DC UPS applications.

### BACKGROUND

The inventive subject matter relates to power supply apparatus and methods and, more particularly, to uninterruptible power supply (UPS) systems and methods.

UPS systems are commonly used in commercial and industrial facilities, such as data centers, telecommunications facilities, factories and hospitals. They are often used to provide reliable, high quality power to critical equipment, such as computer systems.

UPS systems may have any of a number of different types of architectures. For example, AC UPS systems may have an on-line or double conversion architecture including a rectifier configured to be coupled to an AC power source and an inverter coupled to the rectifier by a DC bus and configured to provide AC power to a load. A battery or other DC source may be coupled to the DC source, which may provide backup power in the event of failure of the AC source. Standby AC UPS systems may include an inverter that is configured to be coupled to a load by a transfer switch that switches a load between the inverter and an AC source. AC UPS system may have other architectures, such as line interactive and delta conversion architectures.

48V DC power distribution systems have been traditionally employed in telecommunications applications, such as in telephone switching centers. Such systems may be served by DC UPS systems that provide power from alternative sources. Higher voltage DC power systems are increasingly being introduced in data center applications, as the use of DC power distribution may reduce conversion losses and provide additional benefits in comparison to conventional AC data center power distribution systems.

### SUMMARY

Some embodiments of the inventive subject matter provide an apparatus including a current source rectifier circuit having an input configured to be coupled to an AC power source and an output configured to be coupled to a load, a coupling circuit configured to couple a DC power source to the current source rectifier, and a control circuit configured to selectively operate the current source rectifier circuit and the coupling circuit to generate a DC output from the AC power source and the DC power source. In some embodiments, the control circuit may be configured to operate the coupling circuit to provide a DC/DC converter circuit that uses an energy storage inductor of the current source rectifier circuit. The apparatus may further include a freewheeling diode shared by the current source rectifier circuit and the DC/DC converter circuit. Such apparatus may be used, for example, in DC UPS applications.

Further embodiments of the inventive subject matter provide an apparatus including a current-source rectifier configured to be coupled to an AC power source and a DC/DC converter configured to be coupled to a DC power source and sharing an energy storage inductor with the current-source rectifier. The apparatus further includes a control circuit configured to selectively operate the current-source rectifier and the DC/DC converter to produce a DC voltage at an output node coupled to the inductor.

In some embodiments, the current-source rectifier may include an active rectifier circuit having an input configured to be coupled to the AC power source. The inductor may couple an output of the active rectifier circuit to an output node. The DC/DC converter may include a coupling circuit configured to couple the inductor to the DC power source. The control circuit may selectively control the active rectifier circuit and the coupling circuit to selectively provide the current-source rectifier and the DC/DC converter, respectively. The apparatus may further include a freewheeling diode shared by the current-source rectifier and the DC/DC converter.

In some embodiments, the coupling circuit may include a switch configured to couple the DC power source to the inductor. The inductor may have a first terminal coupled to the active rectifier circuit and a second terminal coupled to the output node, and the switch may be configured to couple and decouple the DC power source to and from the first terminal of the inductor.

The DC power source may include a battery, and the apparatus may further include a charger circuit configured to charge the battery.

Further embodiments of the inventive subject matter provide a UPS including an input port configured to be coupled to an AC power source, an active rectifier circuit having an input coupled to the input port, an inductor having a terminal coupled to an output of the active rectifier circuit and a switch configured to couple a DC power source to the terminal of the inductor. The UPS may further include a control circuit that operates the active rectifier circuit to provide a current-source rectifier that produces a DC voltage at a second terminal of the inductor from the AC power source and that operates the switch to provide a DC/DC converter that produces a DC voltage at the second terminal of the inductor from the DC power source. The control circuit may be configured to operate the DC/DC converter to produce the DC voltage responsive to a failure of the AC power source.

### BRIEF DESCRIPTION OF THE DRAWINGS

FIG. 1 is a schematic diagram illustrating a UPS system according to some embodiments of the inventive subject matter.

FIG. 2 is a schematic diagram illustrating a UPS system according to further embodiments.

FIG. 3 is a schematic diagram illustrating a control architecture for the UPS system of FIG. 2.

FIGS. 4 and 5 are schematic diagrams illustrating applications of a UPS system in data centers according to some embodiments.

### DETAILED DESCRIPTION

Specific exemplary embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like elements. It will be understood that when an element is referred to as being “connected” or “coupled” to another element, it can be directly connected or coupled to the other element or intervening elements may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

Some embodiments of the inventive subject matter arise from a realization that current source rectifiers can be advantageously adapted for use in UPS applications. Current source rectifier circuits may be particularly advantageous for UPS applications because they can produce sinusoidal input currents with desirably low harmonic distortion and can effectively limit output current under fault conditions. Some embodiments may use circuit configurations that allow interfacing of a battery or other backup DC power source to the current source rectifier using relatively few components by sharing components between the current source rectifier and battery interface circuitry.

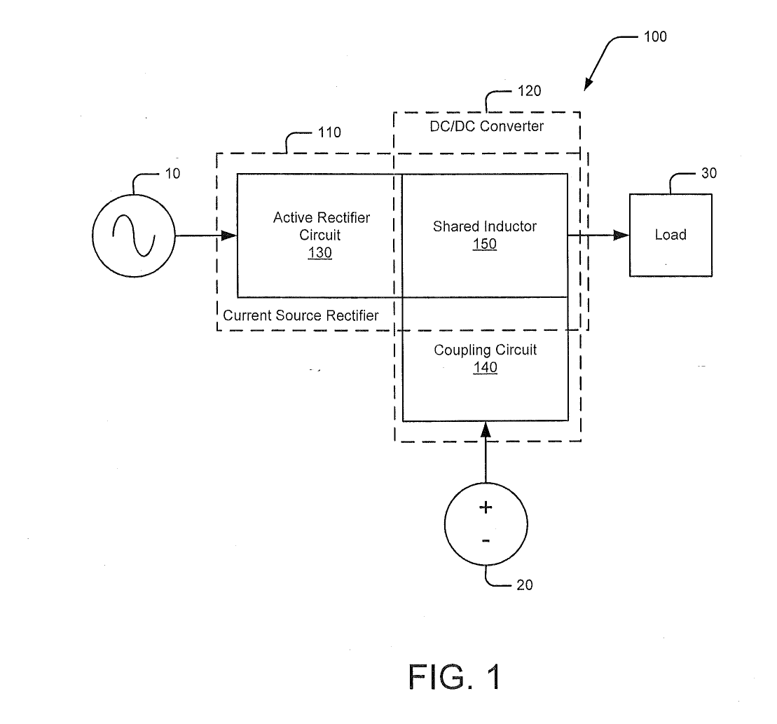

FIG. 1 illustrates an uninterruptible power supply apparatus 100 according to some embodiments of the inventive subject matter. The apparatus 100 includes an active rectifier circuit 130, which is configured to be coupled to an AC power source 10, such as a utility power source and/or local generator. The apparatus 100 further includes a coupling circuit 140 configured to be coupled to a DC power source 20, such as a battery, fuel cell, flywheel power source or the like. The active rectifier circuit 130 and the coupling circuit 140 are configured to implement a current source rectifier 110 and a DC/DC converter 120 using a shared energy storage inductor 150. The current source rectifier 110 is configured to provide DC power to a load 30 from the AC power source 10. The DC/DC converter 120 is configured to provide DC power to the load 30 from the DC power source 20. In some embodiments, the DC/DC converter 120 may be used to provide power to the load 30 from the DC power source 20 in the event of a failure of the AC power source 10 and/or the active rectifier circuit 130.

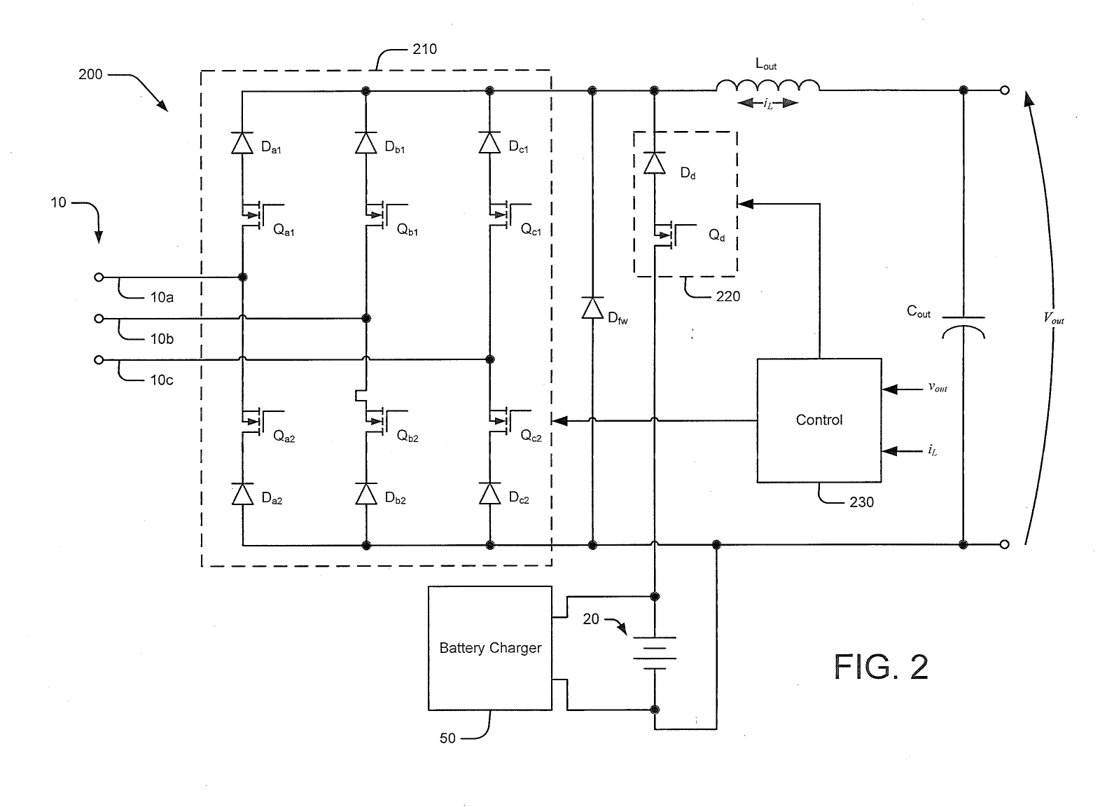

FIG. 2 illustrates an exemplary implementation of the architecture illustrated in FIG. 1 according to further embodiments. A UPS system 200 includes a three-phase active rectifier circuit 210 including three bridge circuits coupled to respective phases 10a, 10b, 10c of an AC source 10. The bridge circuits include upper transistor switches Qₐ₁, Q_{b1}, Q_{c1} and lower transistor switches Qₐ₂, Q_{b2}, Q_{c2} (here shown as power MOSFETs), which are configured to selectively couple the phases 10a, 10b, 10c to first and second DC busses 215a, 215b at an output of the active rectifier circuit 210. Upper and lower diodes Dₐ₁, D_{b1}, D_{c1}, Dₐ₂, D_{b2}, D_{c2} are configured to prevent backfeed through the transistors Qₐ₁, Q_{b1}, Q_{c1}, Qₐ₂, Q_{b2}, Q_{c2} from the buses 215a, 215b. The output of the active rectifier circuit 210 is coupled to an inductor Lₒᵤₜ and a capacitor Cₒᵤₜ, and a freewheeling diode D_{fw} is coupled across the output of the active rectifier circuit 210. The active rectifier circuit 210, freewheeling diode D_{fw}, and inductor Lout may be operated as a current source rectifier that produces a DC output voltage Vₒᵤₜ across the capacitor Cout from the AC power source 10. In particular, a control circuit 230 may control the transistors Qₐ₁, Q_{b1}, Q_{c1}, Qₐ₂, Q_{b2}, Q_{c2} responsive to the output voltage Vₒᵤₜ and a current i_{L} through the inductor Lₒᵤₜ to regulate the output voltage Vₒᵤₜ. It will be understood that the capacitor Cₒᵤₜ may be included in the UPS system 220 as shown in FIG. 2 and/or may be provided by a capacitance included in a load coupled to the UPS system 220.

The UPS system 200 further includes a coupling circuit 220 is configured to selectively couple a battery 20 to the inductor Lₒᵤₜ. The coupling circuit 220 includes a transistor switch Q_{d} and a blocking diode D_{d}. The coupling circuit 220, the freewheeling diode D_{fw} and the inductor Lₒᵤₜ may be operated as a DC/DC converter circuit, in particular, a buck converter, that produces the DC output voltage Vₒᵤₜ from the battery 20. In particular, the control circuit 230 may control the transistor Q_{d} of the coupling circuit 220 responsive to the inductor current I_{L} and the output voltage Vₒᵤₜ. The DC/DC converter may be operated, for example, to maintain the output voltage Vₒᵤₜ in the event of failure of the. AC power source 10 and/or the active rectifier circuit 210.

In some embodiments, a separate charger circuit 50 may charge the battery 20. The charging circuit 50 may be powered, for example, by one or more of the phases 10a, 10b, 10c of the AC power source 10. The charger circuit 50 and/or the battery 20 may be integrated with the UPS system 200 in a single assembly, or may be located in one or more separate assemblies electrically coupled to the UPS system 200.

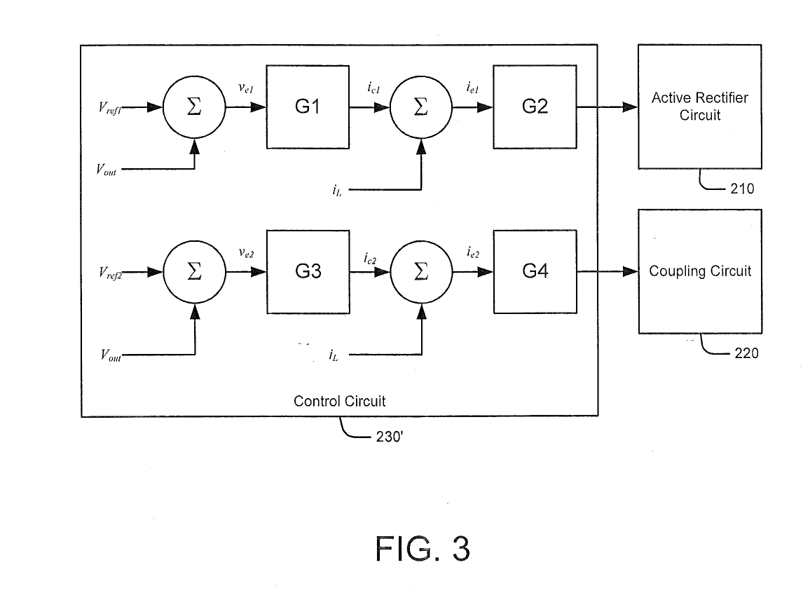

FIG. 3 illustrates an example of a control architecture that may be implemented by the control circuit 230 to support the two modes of operation described above. As shown, a control circuit 230′ may provide a first pair of nested control loops for controlling the active rectifier circuit 230 when operating the system 200 as a current source rectifier to provide power to a load from the AC source. The loops include an outer voltage control loop that generates a voltage error signal vₑ₁ based on a comparison of the output voltage vₒᵤₜ to a reference v_{ref1}, and applies a first compensation function G1 to the error to generate a command i_{c1} for an inner current loop. The inner current loop compares the inductor current i_{L} to the command i_{c1} to generate a current error signal 1ₑ₁. A second compensation function is applied to the current error signal iₑ₁ to generate a control signal (e.g., a pulse width modulated (PWM) signal) for the active rectifier circuit 210.

The control circuit 230′ also provides a second pair of nested loops for controlling the coupling circuit 220 when the system 200 is operating as a DC/DC converter for powering an attached load from the battery 20. The loops include an outer voltage control loop that generates a voltage error signal vₑ₂ based on a comparison of the output voltage vₒᵤₜ to a reference v_{ref2}, which may be the same as the first voltage reference v_{ref1}. A third compensation function G3 is applied to the voltage error signal vₑ₂ to generate a command i_{c2} for an inner current loop. The inner current loop compares the inductor current I_{L} to the command i_{c2} to generate a current error signal iₑ₂. A fourth compensation function G4 is applied to the current error signal iₑ₂ to generate a control signal (e.g., a PWM waveform) for the coupling circuit 220.

It will be appreciated that the control circuit 230′ may be implemented using any of a variety of different types of electronic circuits, such as microcontroller-based circuits which implement the control architecture illustrated using computer instructions executing on data processor, along with peripheral circuitry for interfacing such digital circuitry to switching and sensing devices of the active rectifier circuit 210 and the coupling circuit 220. It will be further appreciated that the control architectures illustrated may also be implemented using functionally similar analog circuitry.

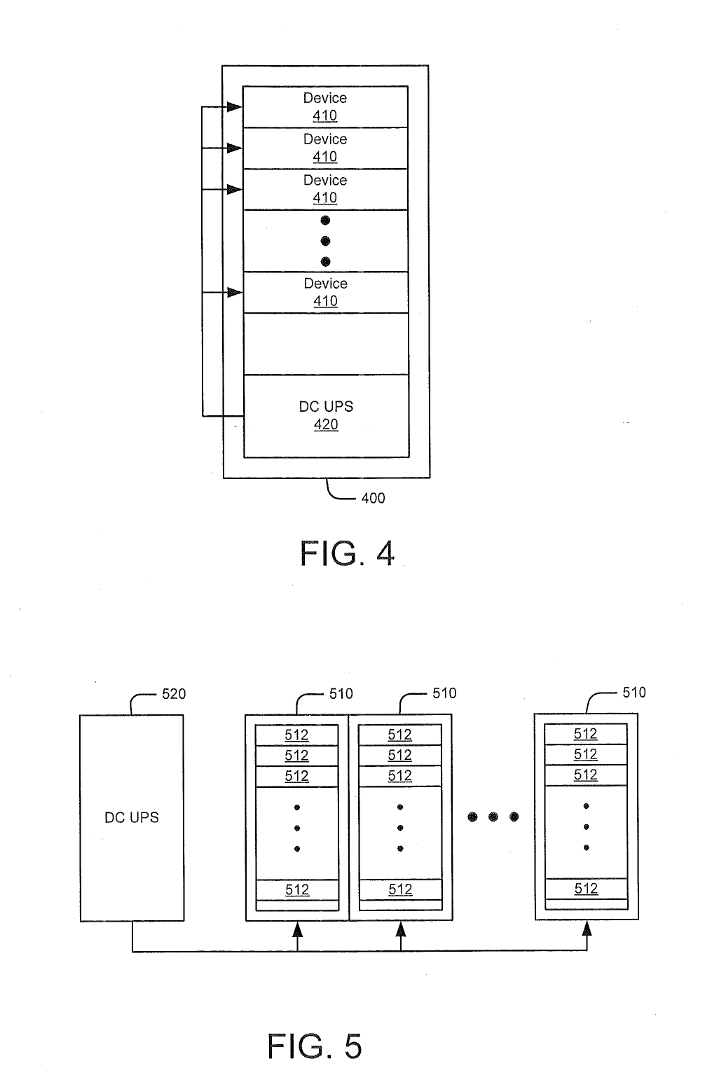

UPS systems along the lines described above may be advantageously applied in power distribution systems for data centers and other electronic systems. For example, as illustrated in FIG. 4, UPS systems such as those illustrated in FIGS. 1-3 may be used in a DC UPS 420 configured to be installed in an equipment rack 400 that houses one or more devices 410, such as servers, routers, hubs and/or other data processing or network devices. The DC UPS 420 may provide DC power to the devices 410 to directly or indirectly power motherboards and/or other systems in the devices 410. Referring to FIG. 5, a DC UPS 520 may be similarly used to provide DC power to multiple racks 510 in a data center or similar facility, each rack 510 housing multiple devices 512 powered by the DC UPS 520.

In the drawings and specification, there have been disclosed exemplary embodiments of the inventive subject matter. Although specific terms are employed, they are used in a generic and descriptive sense only and not for purposes of limitation, the scope of the inventive subject matter being defined by the following claims.

That which is claimed:

1. An apparatus comprising:
a current source rectifier circuit having an input configured to be coupled to an AC power source and an output configured to be coupled to a load;
a coupling circuit configured to couple a DC power source to the current source rectifier; and
a control circuit configured to selectively operate the current source rectifier circuit and the coupling circuit to generate a DC output from the AC power source and the DC power source.

2. The apparatus of claim 1, wherein the control circuit is configured to operate the coupling circuit to provide a DC/DC converter circuit that uses an energy storage inductor of the current source rectifier circuit.

3. The apparatus of claim 2, further comprising a freewheeling diode shared by the current source rectifier circuit and the DC/DC converter circuit.

4. An apparatus comprising:
a current-source rectifier configured to be coupled to an AC power source;
a DC/DC converter configured to be coupled to a DC power source and sharing an energy storage inductor with the current-source rectifier; and
a control circuit configured to selectively operate the current-source rectifier and the DC/DC converter to produce a DC voltage at an output node coupled to the inductor.

5. The apparatus of claim 4:
wherein the current-source rectifier comprises an active rectifier circuit having an input configured to be coupled to the AC power source;
wherein the inductor couples an output of the active rectifier circuit to an output node;
wherein the DC/DC converter comprises a coupling circuit configured to couple the inductor to the DC power source; and
wherein the control circuit selectively controls the active rectifier circuit and the coupling circuit to selectively provide the current-source rectifier and the DC/DC converter, respectively.

6. The apparatus of claim 5, further comprising a freewheeling diode and wherein the current-source rectifier and the DC/DC converter share the freewheeling inductor.

7. The apparatus of claim 5, wherein the coupling circuit comprises a switch configured to couple the DC power source to the inductor.

8. The apparatus of claim 7, wherein the inductor has a first terminal coupled to the active rectifier circuit and a second terminal configured to be coupled to the output node, and wherein the switch is configured to couple and decouple the DC power source to and from the first terminal of the inductor.

9. The apparatus of claim 4, further comprising the DC power source.

10. The apparatus of claim 4, wherein the DC power source comprises a battery.

11. The apparatus of claim 10, further comprising a charger circuit configured to charge the battery.

12. An uninterruptible power supply (UPS) comprising the apparatus of claim 4.

13. A DC power distribution system comprising the apparatus of claim 4.

14. A data center power distribution system comprising the apparatus of claim 4.

15. A UPS comprising:
an input port configured to be coupled to an AC power source;
an active rectifier circuit having an input coupled to the input port;
an inductor having a terminal coupled to an output of the active rectifier circuit; and
a switch configured to couple a DC power source to the terminal of the inductor.

16. The UPS of claim 15, further comprising a control circuit that operates the active rectifier circuit to provide a current-source rectifier that produces a DC voltage at a second terminal of the inductor from the AC power source and that operates the switch to provide a DC/DC converter that produces a DC voltage at the second terminal of the inductor from the DC power source.

17. The UPS of claim 16, wherein the control circuit is configured to operate the DC/DC converter to produce the DC voltage responsive to a failure of the AC power source.

18. The UPS of claim 16, further comprising a freewheeling diode coupled to the output of the active rectifier circuit.

19. The UPS of claim 15, wherein the DC power source comprises a battery.

20. The UPS of claim 19, further comprising a charger circuit configured to charge the battery.
